(19) United States
(12) Patent Application Publication
(10) Pub. No.: US 2018/0033228 A1
(43) Pub. Date: Feb. 1, 2018

(54) PAPER SHEET STORING MECHANISM, PAPER SHEET HANDLING MACHINE, AND PAPER SHEET STORING METHOD

(71) Applicant: GLORY LTD., Himeji-shi, Hyogo (JP)

(72) Inventors: Masayuki AKAGI, Hyogo (JP); Takahiro OE, Hyogo (JP); Kazuhiko TAKAHASHI, Hyogo (JP); Takeshi YOKAWA, Hyogo (JP)

(73) Assignee: GLORY LTD., Himeji-shi, Hyogo (JP)

(21) Appl. No.: 15/549,685

(22) PCT Filed: Jan. 28, 2016
(86) PCT No.: PCT/JP2016/052480

§ 371 Date: Aug. 9, 2017

(30) Foreign Application Priority Data
Feb. 9, 2015 (JP) 2015-023661

(51) Int. Cl. G07D 11/00; B65B 5/04

(52) U.S. Cl. CPC G07D 11/0045; G07D 11/0084; G07D 11/0006; B65B 5/045; G07D 11/0054; G07D 11/003

(57) ABSTRACT

A paper sheet storing mechanism (for example, a banknote storing mechanism (32)) includes an image capturing unit (60) that can capture an image of an inside of a storage bag (for example, a banknote storage bag (34)) held by holding unit (for example, holding members (36)), and a control unit (50) that determines a storing state of a paper sheet in the storage bag based on the image of the inside of the storage bag captured by the image capturing unit (60).

### TECHNICAL FIELD

The present invention relates to a paper sheet storing mechanism that stores a paper sheet, such as a banknote, in a storage bag, such as a pouch bag, having an opening on one side thereof. The present invention also relates to a paper sheet handling machine equipped with such a paper sheet storing mechanism, and a paper sheet storing method implemented by such a paper sheet storing mechanism.

### BACKGROUND ART

A paper sheet handling machine, which performs a money deposition process of a paper sheet, such as a banknote, that stores the paper sheet taken inside a body thereof in a storage bag, such as a pouch bag, is known in the art. A paper sheet handling machine disclosed, for example, in Japanese Patent Application Laid-Open No. 2012-174130 is known as a paper sheet handling machine of this type. According to Japanese Patent Application Laid-Open No. 2012-174130, such a paper sheet handling machine is used as a part of a cash teller machine (specifically, as a banknote teller machine) that is installed, for example, in a backyard area of a shop of a supermarket and the like. The cash teller machine is used to dispense money as a change reserve money to be loaded in a cash settlement device that is installed in a front area and to deposit money as proceeds of sales collected from the cash settlement device.

In the conventional paper sheet handling machine, when storing the paper sheet, such as the banknote, in a storage bag, such as a pouch bag, the number of paper sheets stored in the storage bag is counted in a counting unit, and it is determined that the storage bag is full of the paper sheets when the number of paper sheets stored in the storage bag reaches a predetermined number. That is, when the paper sheet is to be stored in a cassette-type storing unit, various sensors or a full detection lever can be arranged near the storing unit, and whether the storing unit is full or nearly full of the banknotes can be detected by using those sensors or the full detection lever; however, it is difficult to arrange such sensors or the full detection lever for a storage bag such as the pouch bag. Specifically, because the storage bag, such as the pouch bag, is not transparent on account of maintaining the security, it is not possible to directly detect the paper sheet stored in the storage bag from the outside of the storage bag with an optical sensor and the like. Moreover, when a mechanical component such as the full detection lever is used, an issue about space and cost arises as it is necessary to move the mechanical component upward from the storage bag when sealing the opening of the storage bag. Therefore, in the conventional paper sheet handling machine, the number of paper sheets stored in the storage bag is counted, and the operation of storing the paper sheet in the storage bag is stopped before the paper sheets overflow from the storage bag.

### SUMMARY OF INVENTION

However, in the conventional paper sheet handling machine, when counting the number of paper sheets stored in the storage bag, determining that the storage bag is full or nearly full with the paper sheets when the number of paper sheets stored in the storage bag reaches the predetermined number, and stopping the operation of storing the paper sheet in this storage bag, considering that a large number of inappropriate paper sheets, such as unfit banknotes, that may be curled and the like due to being in circulation for a long time, are stored in the storage bag, a number that is much smaller than the capacity of the storage bag when only normal paper sheets, such as new banknotes, are stored in the storage bag is set as the predetermined number. Therefore, when a large number of the normal paper sheets are stored in the storage bag, a large space remains empty in the storage bag even when the number of paper sheets stored in the storage bag has reached the predetermined number. Thus, there is a disadvantage that the storage space in the storage bag is not used effectively.

The present invention has been made in view of the above discussion. One object of the present invention is to provide a paper sheet storing mechanism, a paper sheet handling machine, and a paper sheet storing method that make it possible to store a large number of paper sheets in the storage bag regardless of a state of the paper sheets stored in the storage bag allowing effective use of the storage space in the storage bag.

A paper sheet storing mechanism of the present invention is a paper sheet storing mechanism that stores a paper sheet in a storage bag having an opening on one side thereof, including a holding unit for holding a part near the opening of the storage bag; an image capturing unit that captures an image of an inside of the storage bag held by the holding unit; and a control unit that determines a storing state of the paper sheet in the storage bag based on the image of the inside of the storage bag captured by the image capturing unit.

In the paper sheet storing mechanism of the present invention, upon determining that the storing state of the paper sheet in the storage bag held by the holding unit is a predetermined storing state, the control unit may output information representing that the storing state of the paper sheet in the storage bag is the predetermined storing state.

In this case, the paper sheet storing mechanism of the present invention may further include an alarm unit that raises an alarm, when the control unit determines that the storing state of the paper sheet in the storage bag held by the holding unit is the predetermined storing state, that the storing state of the paper sheet in the storage bag is the predetermined storing state, based on the information output from the control unit.

In the paper sheet storing mechanism of the present invention, a mark for determining the storing state of the paper sheet in the storage bag may be arranged on an inner part of the storage bag to be held by the holding unit.

In this case, the mark may include a plurality of indicator lines that extends parallel to each other, and the control unit may determine the storing state of the paper sheet in the storage bag from the image of the inside of the storage bag captured by the image capturing unit based on a state of discontinuity of one or some of the auxiliary lines among the auxiliary lines because of the paper sheet stored in the storage bag.

Alternatively, the control unit may determine the storing state of the paper sheet in the storage bag from the image of the inside of the storage bag captured by the image capturing unit based on a distance between an upper edge of the paper sheet stored in the storage bag and an upper edge of the storage bag or a predetermined reference line.

Alternatively, the control unit may determine the storing state of the paper sheet in the storage bag from the image of the inside of the storage bag captured by the image capturing unit based on a size of an area between an upper edge of the paper sheet stored in the storage bag and an upper edge of the storage bag or a predetermined reference line.

In the paper sheet storing mechanism of the present invention, information about a counting result representing number of paper sheets sent in the storage bag held by the holding unit may be sent to the control unit, and the control unit may determine the storing state of the paper sheet in the storage bag based on both the image of the inside of the storage bag captured by the image capturing unit and the number of paper sheets sent in the storage bag.

The paper sheet storing mechanism of the present invention may further include a light source that emits a light on the storage bag held by the holding unit.

In this case, the light source may irradiate the inside of the storage bag held by the holding unit with the light.

Alternatively, the light source may irradiate the inside of the storage bag with the light that is transmitted through the storage bag held by the holding unit from outside of the storage bag.

In the paper sheet storing mechanism of the present invention, the image capturing unit may be capable of capturing the image of the inside of a plurality of the storage bags held by the holding units.

In this case, the image capturing unit may include a fisheye lens or a wide-angle lens.

In the paper sheet storing mechanism of the present invention, the control unit may acquire unique information about the storage bag based on the image of the storage bag captured by the image capturing unit.

In this case, a unique information displaying unit indicating the unique information of the storage bag may be arranged on an inner part or an outer part of the storage bag to be held by the holding unit.

In the paper sheet storing mechanism of the present invention, the control unit may be capable of detecting an operation of removing the paper sheet from the storage bag based on the image of the storage bag captured by the image capturing unit.

The paper sheet storing mechanism of the present invention may further include a pressing unit that enters into the storage bag held by the holding unit and presses the paper sheet stored inside the storage bag, based on the image of the inside of the storage bag captured by the image capturing unit, upon determining that the storing state of the paper sheet in the storage bag is the predetermined state, the control unit may control the pressing unit to press the paper sheet stored inside the storage bag.

A paper sheet handling machine of the present invention is a paper sheet handling machine that handles a paper sheet, including a paper sheet storing mechanism that stores the paper sheet in a storage bag having an opening on one side thereof and includes a holding unit for holding a part near the opening of the storage bag, and an image capturing unit that captures an image of an inside of the storage bag held by the holding unit; a body unit that sends the paper sheet to the paper sheet storing mechanism; and a control unit that determines a storing state of the paper sheet in the storage bag based on the image of the inside of the storage bag captured by the image capturing unit.

In this case, upon determining that the storing state of the paper sheet in the storage bag held by the holding unit of the paper sheet storing mechanism is a predetermined storing state, the control unit may output information representing that the storing state of the paper sheet in the storage bag is the predetermined storing state.

The paper sheet handling machine of the present invention may further include an alarm unit that raises an alarm, when the control unit determines that the storing state of the paper sheet in the storage bag held by the holding unit of the paper sheet storing mechanism is the predetermined storing state, based on the information output from the control unit, that the storing state of the paper sheet in the storage bag is the predetermined storing state.

The paper sheet handling machine of the present invention may further include a housing; and a drawing unit that is capable of being pulled out of the housing, the holding unit and the image capturing unit are arranged in the drawing unit, the control unit, and based on the image of the storage bag captured by the image capturing unit, may be capable of detecting an operation of removing the paper sheet from the storage bag after the drawing unit has been pulled out of the housing.

A paper sheet storing method of the present invention is a paper sheet storing method for storing a paper sheet in a storage bag having an opening on one side thereof, including sending the paper sheet into the storage bag to store the paper sheet in the storage bag; capturing an image of an inside of the storage bag with an image capturing unit; and determining a storing state of the paper sheet in the storage bag based on the image of the inside of the storage bag captured by the image capturing unit.

### BRIEF DESCRIPTION OF DRAWINGS

FIG. 1 is a schematic configurational diagram of an example of a configuration of a banknote handling machine according to an embodiment of the present invention.

FIG. 2 is a perspective view of a configuration of a pair of holding members and the like in a banknote storing mechanism of the banknote handling machine shown in FIG. 1.

FIG. 3 is a perspective view of a configuration of a banknote storage bag to be held by the holding members of the banknote storing mechanism of the banknote handling machine shown in FIG. 1 and the like.

FIG. 4 is a functional block diagram of a configuration of a control system of the banknote handling machine shown in FIG. 1 and the like.

FIG. 5 is an example of an image of an inside of the banknote storage bag captured by an image capturing unit of the banknote storing mechanism of the banknote handling machine shown in FIG. 1 and the like.

FIG. 6 is another example of an image of the inside of the banknote storage bag captured by the image capturing unit of the banknote storing mechanism of the banknote handling machine shown in FIG. 1 and the like.

FIG. 7 is a top view of a situation in which two image capturing units are installed in the banknote storing mechanism of the banknote handling machine shown in FIG. 1 and the like.

FIG. 8 is a schematic configurational diagram of another example of a configuration of the banknote handling machine according to the embodiment of the present invention.

FIG. 9 is an example of an image of an inside of the banknote storage bags captured by the image capturing unit of the banknote storing mechanism of the banknote handling machine shown in FIG. 8.

FIGS. 10(a) to 10(d) depict examples of various layouts of the image capturing unit and a light source in the banknote handling machine shown in FIG. 8 and the like.

FIG. 11 depicts a top view of the banknote storing mechanism of yet another banknote handling machine according to the embodiment of the present invention.

FIG. 12 is a perspective view of another example of a configuration of a banknote storage bag to be held by the holding members of the banknote storing mechanism of the banknote handling machine shown in FIG. 8 and the like.

FIG. 13 is a schematic configurational diagram of yet another example of a configuration of the banknote handling machine according to the embodiment of the present invention.

### DESCRIPTION OF EMBODIMENT

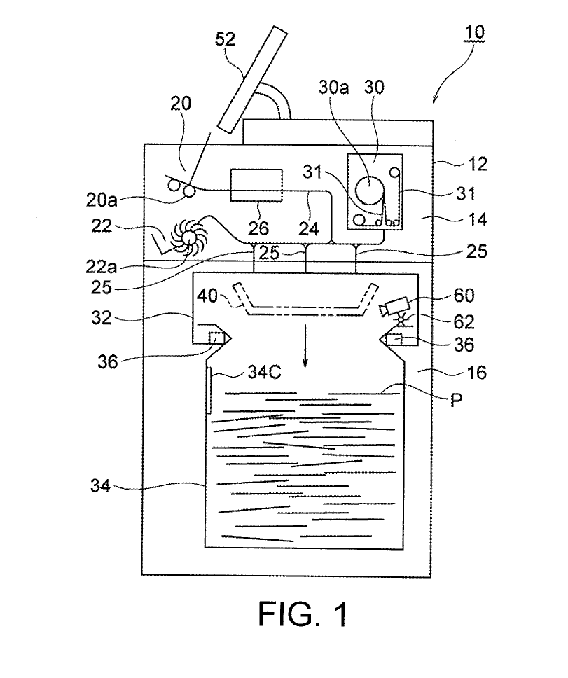

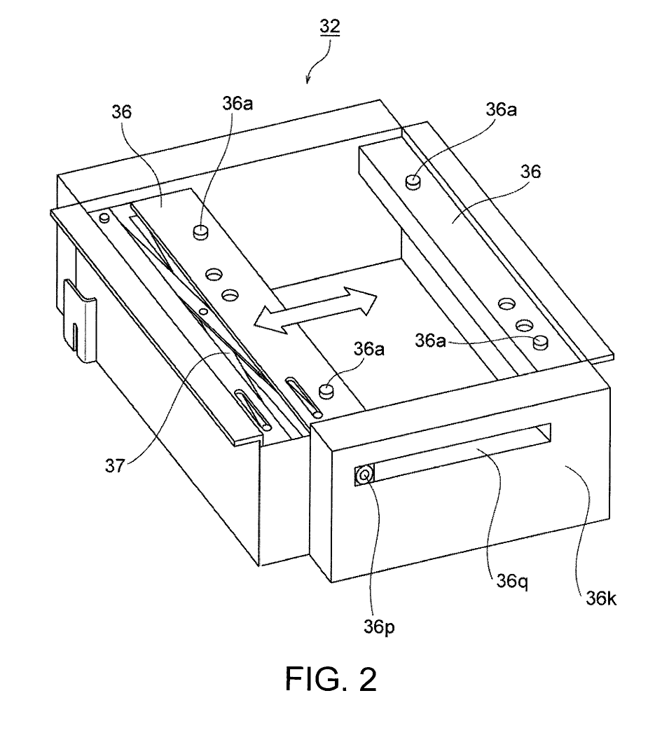

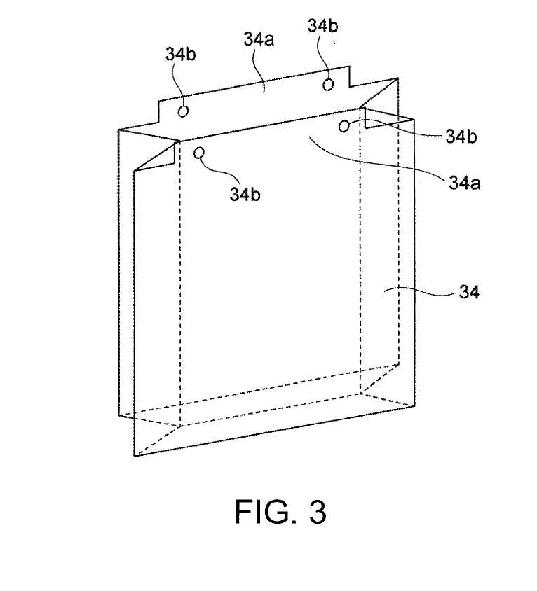

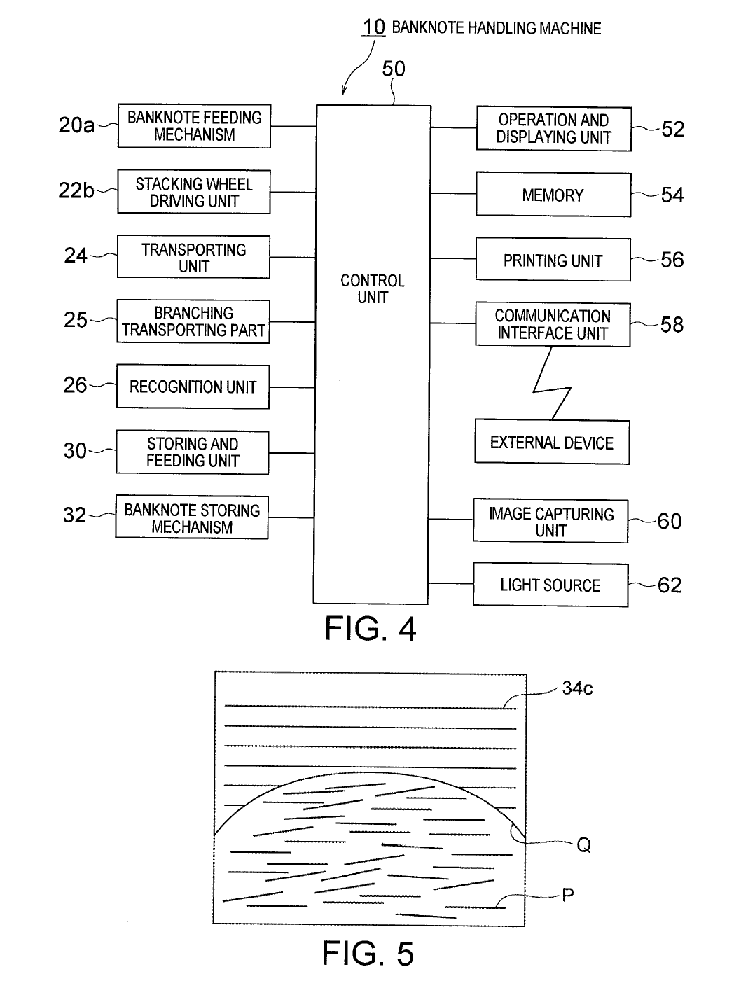

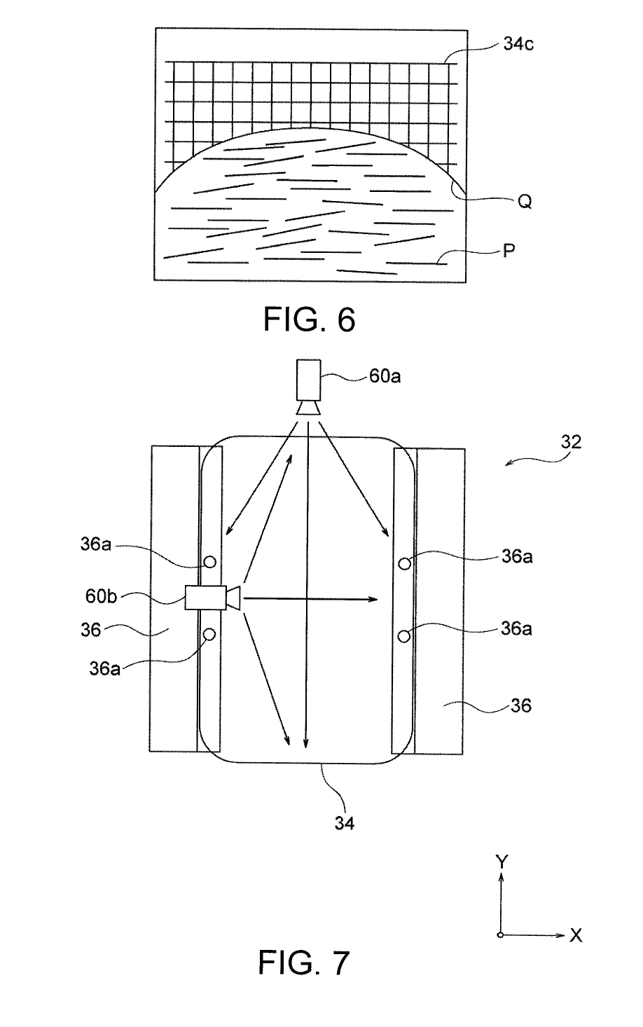

Exemplary embodiments of the present invention are explained below with reference to the accompanying drawings. FIGS. 1 to 6 are views indicating a banknote handling machine and a banknote handling method according to the present embodiment. Among them, FIG. 1 is a schematic configurational diagram of an example of a configuration of the banknote handling machine according to the present embodiment, FIG. 2 is a perspective view of a configuration of a pair of holding members and the like in a banknote storing mechanism of the banknote handling machine shown in FIG. 1, and FIG. 3 is a perspective view of a configuration of a banknote storage bag to be held by the holding members of the banknote storing mechanism shown in FIG. 1 and the like. FIG. 4 is a functional block diagram of a configuration of a control system of the banknote handling machine shown in FIG. 1 and the like. Moreover, FIGS. 5 and 6 are examples of an image of an inside of the banknote storage bag captured by an image capturing unit of the banknote storing mechanism of the banknote handling machine shown in FIG. 1 and the like. Note that, in FIGS. 1 to 6, a banknote stored in the banknote storage bag is shown with a reference letter P.

A banknote handling machine 10 according to the present embodiment is typically installed in a front area or a backyard area of a shop of a supermarket and the like. The banknote handling machine 10 can perform various processes such as a money deposition process of a banknote. As shown in FIG. 1, the banknote handling machine 10 according to the present embodiment includes a housing 12 having a substantially rectangular parallelepiped shape. Note that, a surface on the left-hand side of the housing 12 shown in FIG. 1 is a front surface (the surface facing an operator) of the housing 12. Moreover, an upper unit 14 and a lower unit 16 are housed inside the housing 12 in such a manner that each of them can be pulled out forward from the front surface of the housing 12 (specifically, toward the left direction in FIG. 1). Note that, a structure is allowable in which the lower unit 16 can be pulled out backward from a back surface (specifically, toward the right direction in FIG. 1) instead of the structure in which the lower unit 16 can be pulled out forward from the front surface of the housing 12. In the upper unit 14, a depositing unit 20, such as a receiving hopper, for depositing a banknote from an outside of the housing 12 to an inside thereof is arranged in a front upper surface of the housing 12 (upper left side surface in FIG. 1). Moreover, in the upper unit 14, an ejecting unit 22 for ejecting a banknote to the outside of the housing 12 from the inside thereof is arranged below the depositing unit 20 that has been arranged in the front surface of the housing 12 (the left side surface in FIG. 1).

The depositing unit 20 includes a banknote feeding mechanism 20a to feed banknotes, set on the depositing unit 20 in a stacked manner by the operator, one by one to the inside of the housing 12. Moreover, in the upper unit 14, a transporting unit 24 for transporting the banknotes one by one inside the housing 12 is arranged in the housing 12 of the banknote handling machine 10. The banknotes fed by the banknote feeding mechanism 20a of the depositing unit 20 are transported one by one by the transporting unit 24. Moreover, the transporting unit 24 is provided with a recognition unit 26. The recognition unit 26 recognizes a denomination, authenticity, face side up/back side up, fitness, version, transportation state, and the like of the banknote fed by the banknote feeding mechanism 20a to the transporting unit 24. The recognition unit 26 includes, for example, an image sensor, and a serial number of the banknote is acquired from an image of the banknote captured by the image sensor. Information relating to the serial number of the banknote acquired by the recognition unit 26 is stored in a later-explained memory 54. In this manner, the serial numbers of the banknotes stored in a later-explained banknote storage bag 34, such as a pouch bag, and a storing and feeding unit 30 are stored in the memory 54.

As shown in FIG. 1, the ejecting unit 22 is connected to the transporting unit 24. The banknotes sent from the transporting unit 24 to the ejecting unit 22 are stacked in the ejecting unit 22. Moreover, the ejecting unit 22 is accessible from the outside of the housing 12. The operator can remove the banknotes stacked in the ejecting unit 22 from the front surface of the housing 12. Moreover, a stacking wheel 22a is arranged at a joint of the ejecting unit 22 and the transporting unit 24. The stacking wheel 22a is rotatable in a counterclockwise direction in FIG. 1. When the banknote is sent from the transporting unit 24 to the ejecting unit 22, the stacking wheel 22a rotates in the counterclockwise direction in FIG. 1 while the banknote is sandwiched between two blades of the stacking wheel 22a. As a result, the banknote sandwiched between the two blades of the stacking wheel 22a is stacked and aligned in the ejecting unit 22.

Moreover, in the upper unit 14, the transporting unit 24 is provided with the tape-type storing and feeding unit 30. The banknote sent from the transporting unit 24 to the storing and feeding unit 30 is stored in this storing and feeding unit 30. Moreover, the banknotes stored in this storing and feeding unit 30 can be fed one by one to the transporting unit 24. More particularly, the storing and feeding unit 30 includes a drum 30a rotatable in both of a forward and a reverse direction. One end of a pair of belt-shaped tapes 31 is connected to an outer peripheral surface of the drum 30a. When the banknote is sent from the transporting unit 24 to the storing and feeding unit 30, the banknote is wound one by one, together with and between the tapes 31, around the drum 30a by the belt-shaped tapes 31. Alternatively, when the tapes 31 are unwound from the drum 30a by rotating the drum 30a in the reverse direction, the banknote that has been wound around the drum 30a is also released from the tapes 31 and fed to the transporting unit 24.

As shown in FIG. 1, in the present embodiment, in the lower unit 16 is arranged a banknote storing mechanism 32 that stores the banknotes in the banknote storage bag 34. The banknote storage bag 34 has an opening on one side thereof. The banknote storing mechanism 32 includes a pair of holding members 36. The holding members 36 oppose each other with a space therebetween. Two parts of the banknote storage bag 34 that oppose each other and that are located near the opening are held by the holding members 36. The position of one of the holding members 36 (specifically, for example, the holding member 36 on the right in FIG. 1) is fixed whereas the other holding member 36 (specifically, for example, the holding member 36 on the left in FIG. 1) is movable with respect to the fixed holding member 36. Moreover, each of the holding members 36 includes a not-shown heating element. After the banknotes of a predetermined number are stored in the banknote storage bag 34 held by the holding members 36 of the banknote storing mechanism 32, before the banknote storage bag 34 is removed from the banknote storing mechanism 32, the movable holding member 36 moves toward the fixed holding member 36 so that both the holding members 36 contact each other. In this state, the opening in the banknote storage bag 34 is heat-sealed (heat sealing) by applying heat from the heating elements at places near the opening in the banknote storage bag 34. In the banknote storing mechanism 32, a configuration is allowable in which both the holding members 36 are movable relative to each other so as to contact each other instead of the configuration in which only one of the holding members 36 is movable relative to the other holding member 36.

By pulling the lower unit 16 out forward (i.e., the left direction in FIG. 1) from the front surface of the housing 12, the operator can take out the banknote storage bag 34, which contains the banknotes, from the banknote storing mechanism 32, set an empty banknote storage bag 34 in the banknote storing mechanism 32, and the like.

In the upper unit 14, a plurality of (three in the example shown in FIG. 1) branching transporting parts 25 branches from the transporting unit 24. A banknote branched from the transporting unit 24 to any of the branching transporting part 25 is sent from that branching transporting part 25 to the banknote storage bag 34 set in the banknote storing mechanism 32 and stored in the banknote storage bag 34. In this manner, in the present embodiment, a plurality of banknote inlets from the upper unit 14 to the lower unit 16 has been arranged for one banknote storage bag 34. Moreover, the banknote storage bag 34 having a wide opening, which spans the plurality of (three in the example shown in FIG. 1) inlets from the upper unit 14 to the lower unit 16, is set in the banknote storing mechanism 32. In this structure, regardless of to which of the branching transporting parts 25 the banknote is branched from the transporting unit 24 in the upper unit 14, the banknote will be stored in the same banknote storage bag 34.

In this manner, in the present embodiment, because one banknote storage bag 34 is arranged in the lower unit 16 for the plurality of (specifically, three) inlets from the upper unit 14 to the lower unit 16, the number of banknotes that can be stored in the banknote storage bag 34 can be increased. Moreover, because the plurality of the inlets has been prepared for one banknote storage bag 34 for sending the banknotes to the banknote storage bag 34, the banknotes stored in the banknote storage bag 34 get scattered in the banknote storage bag 34 so that the banknotes can be stored uniformly in the banknote storage bag 34.

In the lower unit 16, it is allowable to arrange a plurality of the banknote storing mechanism 32 side-by-side into each of which the banknote storage bag 34, such as a pouch bag, can be set. Specifically, it is allowable to provide three banknote storing mechanisms 32 arranged side-by-side corresponding to the three branching transporting parts 25. In this structure, each of the banknote storing mechanism 32 includes a pair of holding members that oppose each other with a space therebetween. Two parts of the banknote storage bag 34 that oppose each other and that are located near the opening are held by the holding members 36. In the upper unit 14, a banknote branched from the transporting unit 24 to the branching transporting part 25 is sent from the branching transporting part 25 to the banknote storage bag 34 set in the corresponding banknote storing mechanism 32 and stored in that banknote storage bag 34. Moreover, in this structure, above the holding members in each of the banknote storing mechanism 32 are arranged a temporary escrow unit for temporarily storing the banknote sent from the transporting unit 24 and a pushing plate for pushing the banknote temporarily stored in the temporary escrow unit into the banknote storage bag 34. Specifically, the banknotes sent from the transporting unit 24 to the banknote storing mechanism 32 are stored in a stacked manner in the temporary escrow unit. The pushing plate moves downward when the banknotes, which have been stacked in the temporary escrow unit, are to be stored in the banknote storage bag 34. As a result, the banknotes stacked in the temporary escrow unit are pushed downward and sent in the banknote storage bag 34. Moreover, when the banknotes of a predetermined number are stored in the banknote storage bag 34, the pushing plate moves downward and enters into the banknote storage bag 34 whereby the banknotes stored in the banknote storage bag 34 are pushed downward and compressed by the pushing plate.

A detailed explanation of a configuration of the holding members 36 is given below by using FIG. 2. As shown in FIG. 2, among the pair of holding members 36 arranged on the right and left, the left holding member 36 is provided with a pantograph 37. The left holding member 36 can be moved toward the right holding member 36 by the pantograph 37 so that the holding members 36 contact each other. More particularly, a guide pin 36p is arranged at one end of the left holding member 36, and a frame 36k that supports the holding members 36 is provided with a linear slit 36q for guiding the guide pin 36p. The slit 36q extends horizontally in the frame 36k. When the pantograph 37 expands, the guide pin 36p of the left holding member 36 is guided along the slit 36q whereby the left holding member 36 moves toward the right holding member 36. In the present embodiment, it is allowable to perform the movement of the left holding member 36 by using a rack and a pinion instead of performing the movement of the left holding member 36 by using the pantograph 37.

Moreover, as shown in FIG. 2, two pins 36a are arranged on a top surface of each of the right and left holding members 36. As shown in FIG. 3, the banknote storage bag 34 to be held by the holding members 36 has a pair of protruding parts 34a near the opening thereof (that is, near an upper edge of the banknote storage bag 34), and each of the protruding parts 34a is provided with a pair of holes 34b. When the banknote storage bag 34 is to be held by the holding members 36, the pins 36a of the holding members 36 are inserted in the corresponding holes 34b formed in the corresponding protruding parts 34a of the banknote storage bag 34. As a result, the protruding parts 34a are held by the holding members 36.

Moreover, as shown with a two-dot chain line in FIG. 1, a pushing plate 40 is arranged above the banknote storage bag 34 held by the holding members 36. A not-shown pantograph is arranged above the pushing plate 40. When the pantograph expands downward, the pushing plate 40 is moved downward from its position shown in FIG. 1 and enters into the banknote storage bag 34. In the present embodiment, because of entry of the pushing plate 40 into the banknote storage bag 34, the banknotes that have been stored in the banknote storage bag 34 are pressed further into the banknote storage bag 34 by the pushing plate 40 and are compressed. Accordingly, a storage space for the banknotes in the banknote storage bag 34 can be increased.

As shown in FIG. 1, in the banknote storing mechanism 32, an image capturing unit 60, such as a camera, for capturing an image of an inner wall part of the banknote storage bag 34 is arranged near the opening of the banknote storage bag 34 held by the holding members 36. A mark 34c is arranged on an inner wall part near the opening of the banknote storage bag 34 held by the holding members 36. An image of this mark 34c is captured by the image capturing unit 60. A detailed explanation of the mark 34c arranged on the inner wall part near the opening of the banknote storage bag 34 is given later. Moreover, a light source 62 that emits a light on the inner wall part of the banknote storage bag 34 held by the holding members 36 is arranged near the image capturing unit 60. By emitting the light on the inner wall part of the banknote storage bag 34 from the light source 62, a clear image of the mark 34c, which is arranged on the inner wall part near the opening of the banknote storage bag 34, can be captured by the image capturing unit 60. A detailed explanation of the image captured by the image capturing unit 60 is given later.

As mentioned earlier, in a structure in which three banknote storing mechanisms 32 are arranged side-by-side corresponding to the three branching transporting parts 25, and in the upper unit 14, a banknote branched from the transporting unit 24 to the branching transporting part 25 is sent from the branching transporting part 25 to the banknote storage bag 34 set in the corresponding banknote storing mechanism 32 and stored in the banknote storage bag 34, the image capturing unit 60 is arranged in each of the banknote storing mechanism 32, and an image of the inner wall part of each of the banknote storage bags 34 set in each of the banknote storing mechanism 32 is captured by the corresponding image capturing unit 60.

Moreover, a control unit 50 that controls various structural components of the banknote handling machine 10 is arranged in the banknote handling machine 10 according to the present embodiment. More particularly, as shown in FIG. 4, the banknote feeding mechanism 20a arranged in the depositing unit 20, a stacking wheel driving unit 22b for driving the stacking wheel 22a arranged in the ejecting unit 22, the transporting unit 24, the branching transporting parts 25, the recognition unit 26, the storing and feeding unit 30, the banknote storing mechanism 32, the image capturing unit 60, the light source 62, and the like are connected to the control unit 50 in a communicable manner. A signal representing a recognition result of a banknote by the recognition unit 26 and an image captured by the image capturing unit 60 are sent to the control unit 50. Moreover, the control unit 50 controls the operation of the various structural components of the banknote handling machine 10 by sending a command signal to each of these structural components.

As shown in FIG. 4, an operation and displaying unit 52, the memory 54, a printing unit 56, and a communication interface unit 58 are connected to the control unit 50 in a communicable manner. As shown in FIG. 1, the operation and displaying unit 52 is constituted by, for example, a touch panel and the like arranged on a top surface of the housing 12. A handling state of the money deposition process and the like of the banknote in the banknote handling machine 10, and information about inventory amounts and the like of the banknotes stored in the banknote storage bag 34, are displayed on the operation and displaying unit 52. Moreover, the operator can give various commands to the control unit 50 by operating the operation and displaying unit 52.

The handling history of the money deposition process and the like of the banknote in the banknote handling machine 10, and the information about the inventory amounts and the like of the banknotes stored in the banknote storage bag 34 are stored in the memory 54. Moreover, as mentioned earlier, serial numbers of the banknotes that have been stored in the banknote storage bag 34, such as a pouch bag, and the banknotes stored in the storing and feeding unit 30 are stored in the memory 54. The printing unit 56 prints on a receipt and the like the handling history of the money deposition process and the like of the banknote in the banknote handling machine 10, and the information about the inventory amounts and the like of the banknotes stored in the banknote storage bag 34. The control unit 50 can transmit to and receive a signal from an external device (specifically, for example, a host terminal), provided separately from the banknote handling machine 10 according to the present embodiment, via the communication interface unit 58. For example, when the banknote storage bag 34 is collected by a guard and the like of a secure transportation company, the control unit 50 transmits information about the banknote storage bag 34 to the secure transportation company via the communication interface unit 58.

While the control unit 50 is arranged inside the housing 12 of the banknote handling machine 10 to control the various structural components of the banknote handling machine 10, if the banknote storing mechanism 32 is used singly, a control unit for controlling various structural components of this banknote storing mechanism 32 and/or an operation and displaying unit that also functions as an alarm unit for raising an alarm to the operator as explained below, can be arranged in the banknote storing mechanism 32.

An operation performed by the banknote handling machine 10 having the above-explained configuration is explained below. The operation explained below of the banknote handling machine 10 is realized by the control unit 50 by controlling the various structural components of the banknote handling machine 10.

At first, an operation performed by the banknote handling machine 10 when performing the money deposition process of the banknote is explained below. When the operator sets the banknote in the depositing unit 20 and gives a command to start the money deposition process to the control unit 50 by using the operation and displaying unit 52, the banknotes set in the depositing unit 20 are fed inside the housing 12 one by one by the banknote feeding mechanism 20a, and the banknotes are transported one by one by the transporting unit 24. A denomination, authenticity, face side up/back side up, fitness, version, transportation state, and the like of the banknote transported by the transporting unit 24 are recognized by the recognition unit 26. Moreover, an image of the banknote is captured by the image sensor arranged in the recognition unit 26, and a serial number of the banknote is acquired from the image of the banknote. Information of the serial number of the banknote acquired by the recognition unit 26 is stored in the memory 54. A banknote that is recognized by the recognition unit 26 as not being a normal banknote, i.e., a reject banknote, is sent to the ejecting unit 22 by the transporting unit 24 and stacked in the ejecting unit 22. The operator can manually remove the reject banknote that has been stacked in the ejecting unit 22 from the front surface of the housing 12, and set the reject banknote in the depositing unit 20.

Meanwhile, a banknote that is recognized as being a normal banknote by the recognition unit 26 is branched from the transporting unit 24 to one of the branching transporting parts 25 among the plurality of the branching transporting parts 25, and then sent from that branching transporting part 25 to the banknote storage bag 34 and stored in the banknote storage bag 34.

When the banknote storage bag 34 in which the banknotes recognized by the recognition unit 26 are sent is full or nearly full so that no more banknotes can be stored in the banknote storage bag 34, the banknote recognized by the recognition unit 26 is sent to the storing and feeding unit 30 and stored in the storing and feeding unit 30. When the full or nearly full banknote storage bag 34 is removed from the banknote storing mechanism 32 of the lower unit 16 by a guard of the secure transportation company, a salesclerk of the shop, and the like, and an empty banknote storage bag 34 is set in the banknote storing mechanism 32, the banknotes are fed one by one from the storing and feeding unit 30 to the transporting unit 24 and sent in the banknote storage bag 34 by the transporting unit 24.

In the present embodiment, when the banknote is stored in the banknote storage bag 34 held by the holding members 36 of the banknote storing mechanism 32, an image of the mark 34c arranged on the inner wall part of the banknote storage bag 34 is captured by the image capturing unit 60. As mentioned earlier, in a structure in which three banknote storing mechanisms 32 are arranged side-by-side corresponding to the three branching transporting parts 25, and the temporary escrow unit, the pushing plate, and the image capturing unit 60 are arranged above the holding members of each of the banknote storing mechanism 32, the images of the marks 34c arranged on the inner wall parts of the banknote storage bags 34 are captured by the image capturing units 60 at a timing that is after the banknotes temporarily escrowed in the temporary escrow units are stored in the banknote storage bags 34 by the pushing plates. In a configuration in which the operation of pushing the banknotes, which have been stored in the banknote storage bag 34, downward by the pushing plate when the banknotes of the predetermined number have been stored in the banknote storage bag 34 is performed regularly, the image of the mark 34c arranged on the inner wall part of the banknote storage bag 34 is captured by the image capturing unit 60 after the banknotes stored in the banknote storage bag 34 are pushed downward by the pushing plate.

The control unit 50 determines a storing state of the banknotes in the banknote storage bag 34 based on the image of the inside of the banknote storage bag 34 captured by the image capturing unit 60. When the control unit 50 determines that the storing state is a predetermined storing state (specifically, full or nearly full), the control unit 50 outputs information representing that the storing state of the banknotes in the banknote storage bag 34 is the predetermined storing state. More particularly, when the control unit 50 determines that the storing state of the banknotes in the banknote storage bag 34 is the predetermined storing state, the information representing that the storing state of the banknotes in the banknote storage bag 34 is the predetermined storing state can be displayed on the operation and displaying unit 52, this information can be printed on a receipt and the like by the printing unit 56, or this information can be transmitted to the external device by the communication interface unit 58. The operation and displaying unit 52 functions as the alarm unit for raising the alarm, based on the information output from the control unit 50, the information representing that the storing state of the banknotes in the banknote storage bag 34 is the predetermined storing state, when the control unit 50 determines that the storing state of the banknotes in the banknote storage bag 34 held by the holding members 36 is the predetermined storing state. A detailed explanation of this technical feature is explained below by using FIGS. 5 and 6.

FIG. 5 is an example of an image of the inside of the banknote storage bag 34 captured by the image capturing unit 60 of the banknote storing mechanism 32 of the banknote handling machine 10 shown in FIG. 1 and the like. In the example shown in FIG. 5, as the mark 34c, a plurality of indicator lines that extends horizontally and parallel to each other are formed on the inner wall part near the opening of the banknote storage bag 34. The control unit 50 determines the storing state of the banknotes in the banknote storage bag 34 from the image of the inside of the banknote storage bag 34 captured by the image capturing unit 60 based on a state of discontinuity of some of the auxiliary lines among the auxiliary lines because of the banknotes stored in the banknote storage bag 34. In FIG. 5, an upper edge of the banknotes stored in the banknote storage bag 34 is shown with a reference letter Q.

Specifically, in the image of the inside of the banknote storage bag 34 captured by the image capturing unit 60 as shown in FIG. 5, when the number of auxiliary lines that are not discontinuous by the upper edge (see the reference letter Q in FIG. 5) of the banknotes stored in the banknote storage bag 34 is less than a predetermined number set previously, the control unit 50 determines that the banknote storage bag 34 is full or nearly full. In the image shown in FIG. 5, the number of auxiliary lines that are not discontinuous by the upper edge of the banknotes stored in the banknote storage bag 34 is four. However, when more banknotes are stored in the banknote storage bag 34 from the state shown in FIG. 5, and when the number of auxiliary lines that are not discontinuous by the upper edge of the banknotes stored in the banknote storage bag 34 becomes, for example, less than two, the control unit 50 determines that the banknote storage bag 34 is full or nearly full. As another example, in the image of the inside of the banknote storage bag 34 captured by the image capturing unit 60 shown in FIG. 5, when the total of the number of auxiliary lines that are not discontinuous by the upper edge of the banknotes stored in the banknote storage bag 34 and the number of auxiliary lines whose length of the discontinuous parts by the upper edge of the banknotes is equal to or less than a predetermined value set previously, among the auxiliary lines as the mark 34c, is less than a predetermined value set previously, it is allowable for the control unit 50 to determine that the banknote storage bag 34 is full or nearly full.

FIG. 6 is another example of an image of the inside of the banknote storage bag 34 captured by the image capturing unit 60 of the banknote storing mechanism 32 of the banknote handling machine 10 shown in FIG. 1 and the like. In the example shown in FIG. 6, as the mark 34c, a plurality of indicator lines that extends horizontally and vertically and parallel to each other are formed on the inner wall part near the opening of the banknote storage bag 34. That is, the auxiliary lines form a grid pattern. Accordingly, a plurality of square portions is formed by the auxiliary lines on the inner wall part near the opening of the banknote storage bag 34. The control unit 50 determines the storing state of the banknotes in the banknote storage bag 34 from the image of the inside of the banknote storage bag 34 captured by the image capturing unit 60 based on a state of incompleteness of some of the square portions among the square portions formed by the auxiliary lines because of the banknotes stored in the banknote storage bag 34. In FIG. 6, an upper edge of the banknotes stored in the banknote storage bag 34 is shown with the reference letter Q.

Specifically, in the image of the inside of the banknote storage bag 34 captured by the image capturing unit 60 shown in FIG. 6, when the number of square portions that are not incomplete by the upper edge (see the reference letter Q in FIG. 6) of the banknotes stored in the banknote storage bag 34 is less than a predetermined number set previously, the control unit 50 determines that the banknote storage bag 34 is full or nearly full. In the image shown in FIG. 6, the number of square portions that are not incomplete by the upper edge of the banknotes stored in the banknote storage bag 34 is 46. However, when more banknotes are stored in the banknote storage bag 34 from the state shown in FIG. 6, and when the number of square portions that are not incomplete by the upper edge of the banknotes stored in the banknote storage bag 34 becomes, for example, less than 20, the control unit 50 determines that the banknote storage bag 34 is full or nearly full.

As another example, it is allowable for the control unit 50 to determine the storing state of the banknotes in the banknote storage bag 34 from the image of the inside of the banknote storage bag 34 captured by the image capturing unit 60 based on a distance between the upper edge of the banknotes stored in the banknote storage bag 34 and the upper edge of the banknote storage bag 34 or a predetermined reference line. More particularly, as shown in FIG. 5, assume that a plurality of indicator lines that extends horizontally and parallel to each other are formed on the inner wall part near the opening of the banknote storage bag 34 as the mark 34c. In this structure, it is allowable for the control unit 50 to determine that the banknote storage bag 34 is full or nearly full based on the image of the inside of the banknote storage bag 34 captured by the image capturing unit 60 when the distance between the upper edge (see the reference letter Q in FIG. 5) of the banknotes stored in the banknote storage bag 34 and the upper edge of the banknote storage bag 34 or the predetermined reference line (for example, the topmost auxiliary line among the auxiliary lines as the mark 34c) is less than a predetermined distance set previously.

As yet another example, it is allowable for the control unit 50 to determine the storing state of the banknotes in the banknote storage bag 34 from the image of the inside of the banknote storage bag 34 captured by the image capturing unit 60 based on a size of an area between the upper edge of the banknotes stored in the banknote storage bag 34 and the upper edge of the banknote storage bag 34 or the predetermined reference line. More particularly, as shown in FIG. 5, assume that a plurality of indicator lines that extends horizontally and parallel to each other are formed on the inner wall part near the opening of the banknote storage bag 34 as the mark 34c. In this structure, it is allowable for the control unit 50 to determine that the banknote storage bag 34 is full or nearly full based on the image of the inside of the banknote storage bag 34 captured by the image capturing unit 60 when the size of the area between the upper edge (see the reference letter Q in FIG. 5) of the banknotes stored in the banknote storage bag 34 and the upper edge of the banknote storage bag 34 or the predetermined reference line (for example, the topmost auxiliary line among the auxiliary lines as the mark 34c) is less than a predetermined size set previously.

In the present embodiment, information about a counting result representing the number of banknotes sent in the banknote storage bag 34 based on the recognition result of the banknote by the recognition unit 26 is sent to the control unit 50, and it is allowable for the control unit 50 to determine the storing state of the banknotes in the banknote storage bag 34 based on both the image of the inside of the banknote storage bag 34 captured by the image capturing unit 60 and the number of banknotes sent in the banknote storage bag 34. Specifically, even when the control unit 50 determines that the banknote storage bag 34 is not full or not nearly full based on the image of the inside of the banknote storage bag 34 captured by the image capturing unit 60, but if the control unit 50 determines that the number of banknotes sent in the banknote storage bag 34 has exceeded a predetermined number set previously (more specifically, a number that is large enough to determine that the banknote storage bag 34 is full or nearly full) from the recognition result of the banknote obtained in the recognition unit 26, the control unit 50 outputs information that indicates that the banknote storage bag 34 is in the predetermined storing state (specifically, full or nearly full). Further, from the recognition result of the banknote obtained in the recognition unit 26, even when the control unit 50 determines that the number of banknotes sent in the banknote storage bag 34 has not exceeded the predetermined number set previously, but if the control unit 50 determines that the banknote storage bag 34 is full or nearly full based on the image of the inside of the banknote storage bag 34 captured by the image capturing unit 60, the control unit 50 outputs the information that indicates that the banknote storage bag 34 is in the predetermined storing state (specifically, full or nearly full).

Based on internal information of the banknote storage bag 34 captured by the image capturing unit 60 (specifically, information relating to the upper edge of the banknotes stored in the banknote storage bag 34), the control unit 50 can determine whether there is an unevenness in a lateral direction in the storing state of the banknotes stored in the banknote storage bag 34. Upon determining that there is the unevenness in the lateral direction in the storing state of the banknotes stored in the banknote storage bag 34, the control unit 50 causes the pushing plate 40 to move downward from its position shown in FIG. 1 and enter into the banknote storage bag 34. In this manner, because of entry of the pushing plate 40 into the banknote storage bag 34, the banknotes stored in the banknote storage bag 34 are pressed further inside the banknote storage bag 34 by the pushing plate 40 and are compressed. Accordingly, the unevenness in the lateral direction in the storing state of the banknotes stored in the banknote storage bag 34 can be removed. The operation of pushing the banknotes in the banknote storage bag 34 downward by the pushing plate 40 is performed each time a predetermined number of the banknotes are stored in the banknote storage bag 34. Moreover, when the banknote storage bag 34 is determined to be full or nearly full based on the image of the inside of the banknote storage bag 34 captured by the image capturing unit 60 even if the banknote storage bag 34 is not really full or nearly full, the banknotes in the banknote storage bag 34 are pressed downward by the pushing plate 40 and compressed.

The banknote handling machine 10 according to the present embodiment and the banknote storing mechanism 32 included in the banknote handling machine 10 having the configuration as explained above includes the image capturing unit 60, such as a camera, that can capture an image of the inside of the banknote storage bag 34 held by the holding members 36, and the control unit 50 determines the storing state of the banknotes in the banknote storage bag 34 based on the image of the inside of the banknote storage bag 34 captured by the image capturing unit 60. In this manner, by capturing the image of the inside of the banknote storage bag 34 held by the holding members 36 with the image capturing unit 60, and determining the storing state of the banknotes in the banknote storage bag 34 based on the captured image of the inside of the banknote storage bag 34, a large number of banknotes can be stored in the storage bag regardless of the state of the banknotes stored in the banknote storage bag 34, and the storage space in the banknote storage bag 34 can be used effectively. More specifically, in the conventional technique, the number of banknotes stored in the banknote storage bag is counted, it is determined that the banknote storage bag is full or nearly full when the number of banknotes stored in the banknote storage bag has reached a predetermined number and the operation of storing the banknotes in the banknote storage bag is stopped. However, considering that a large number of inappropriate banknotes, such as unfit banknotes, that may be curled and the like due to being in circulation for a long time, are stored in the banknote storage bag, a number that is much smaller than the capacity of the banknote storage bag when only normal banknotes, such as new banknotes, are stored in the banknote storage bag is set as the predetermined number. Therefore, when storing a large number of the normal banknotes in the banknote storage bag, a large space remains empty inside the banknote storage bag even when the number of the banknotes stored in the banknote storage bag has reached the predetermined number. Thus, the storage space in the banknote storage bag is not used effectively. In contrast, in the banknote handling machine 10 according to the present embodiment and the banknote storing mechanism 32 included in the banknote handling machine 10, whether the banknote storage bag 34 is full or nearly full is determined based on the actual state of the banknotes stored in the banknote storage bag 34. A large number of the banknotes can be stored in the banknote storage bag 34 regardless of whether the banknotes stored in the banknote storage bag 34 are normal banknotes or banknotes that are curled and the like due to being in circulation for a long time.

Moreover, in the banknote handling machine 10 according to the present embodiment and the banknote storing mechanism 32 included in the banknote handling machine 10, as mentioned earlier, upon determining that the storing state of the banknotes in the banknote storage bag 34 held by the holding members 36 is the predetermined storing state, the control unit 50 outputs information representing that the storing state of the banknotes in the banknote storage bag 34 is the predetermined storing state. Moreover, when the control unit 50 determines that the storing state of the banknotes in the banknote storage bag 34 held by the holding members 36 is the predetermined storing state, based on the information output from the control unit 50, the information representing that the storing state of the banknotes in the banknote storage bag 34 is the predetermined storing state is alarmed by the alarm unit such as the operation and displaying unit 52.

In the banknote handling machine 10 according to the present embodiment and the banknote storing mechanism 32 included in the banknote handling machine 10, as mentioned earlier, the mark 34c that serves as the reference for determining the storing state of the banknotes in the banknote storage bag 34 is arranged on an inner part of the banknote storage bag 34 held by the holding members 36. More particularly, as shown in FIG. 5, the indicator lines that extends horizontally and parallel to each other constitute the mark 34c. The control unit 50 determines the storing state of the banknotes in the banknote storage bag 34 from the image of the inside of the banknote storage bag 34 captured by the image capturing unit 60 based on the state of discontinuity of some of the auxiliary lines among the auxiliary lines because of the banknotes stored in the banknote storage bag 34. Alternately, it is allowable for the control unit 50 to determine the storing state of the banknotes in the banknote storage bag 34 from the image of the inside of the banknote storage bag 34 captured by the image capturing unit 60 based on the distance between the upper edge of the banknotes and the upper edge of the banknote storage bag 34 or the predetermined reference line. As yet another example, it is allowable for the control unit 50 to determine the storing state of the banknotes in the banknote storage bag 34 from the image of the inside of the banknote storage bag 34 captured by the image capturing unit 60 based on the size of the area between the upper edge of the banknotes and the upper edge of the banknote storage bag 34 or the predetermined reference line.

In the banknote handling machine 10 according to the present embodiment and the banknote storing mechanism 32 included in the banknote handling machine 10, as mentioned earlier, the information about the counting result representing the number of banknotes sent in the banknote storage bag 34 held by the holding members 36 is sent to the control unit 50, and it is allowable for the control unit 50 to determine the storing state of the banknotes in the banknote storage bag 34 based on both the image of the inside of the banknote storage bag 34 captured by the image capturing unit 60 and the number of banknotes sent in the banknote storage bag 34.

In the banknote handling machine 10 according to the present embodiment and the banknote storing mechanism 32 included in the banknote handling machine 10, as mentioned earlier, the light source 62 is arranged that emits the light on the banknote storage bag 34 held by the holding members 36. Specifically, the light source 62 emits the light in the banknote storage bag 34 held by the holding members 36.

In the banknote handling machine 10 according to the present embodiment and the banknote storing mechanism 32 included in the banknote handling machine 10, as mentioned earlier, the pushing plate 40 and the pantograph that operates this pushing plate 40 are arranged as a pressing unit that enters into the banknote storage bag 34 held by the holding members 36 and presses the banknotes stored in the banknote storage bag 34. Based on the image of the inside of the banknote storage bag 34 captured by the image capturing unit 60, upon determining that the storing state of the banknotes in the banknote storage bag 34 is the predetermined state (specifically, there is the unevenness in the lateral direction in the storing state of the banknotes), the control unit 50 controls the pantograph of the pushing plate 40 to operate the pushing plate 40 and press the banknotes stored in the banknote storage bag 34.

The banknote handling machine 10 according to the present embodiment and the banknote storing mechanism 32 included in the banknote handling machine 10 are not limited to the above-explained embodiments and various changes can be made as appropriate.

For example, as shown in FIG. 7, two image capturing units 60a and 60b can be arranged for the one banknote storing mechanism 32. FIG. 7 is a top view of a situation in which the two image capturing units 60a and 60b are installed for the banknote storing mechanism 32 of the banknote handling machine 10 shown in FIG. 1 and the like. In this manner, when the two image capturing units 60a and 60b are arranged for one banknote storing mechanism 32, directions from which an image of the inner wall part of the banknote storage bag 34 is captured by each of the image capturing units 60a and 60b are orthogonal to each other. Accordingly, whether there is the unevenness in the lateral direction in the storing state of the banknotes stored in the banknote storage bag 34 can be detected from various directions. For example, when the banknote storing mechanism 32 includes only one image capturing unit 60, it is possible to detect from only one direction whether the unevenness in the lateral direction has occurred in the storing state of the banknotes stored in the banknote storage bag 34. However, as shown in FIG. 7, when the two image capturing units 60a and 60b are arranged for one banknote storing mechanism 32, whether the unevenness in the lateral direction has occurred in the storing state of the banknotes stored in the banknote storage bag 34 can be detected in an X-direction (specifically, an imaging direction of the image capturing unit 60b) and a Y-direction (specifically, an imaging direction of the image capturing unit 60a). Therefore, it can be more surely detected whether the unevenness in the lateral direction has occurred in the storing state of the banknotes stored in the banknote storage bag 34.

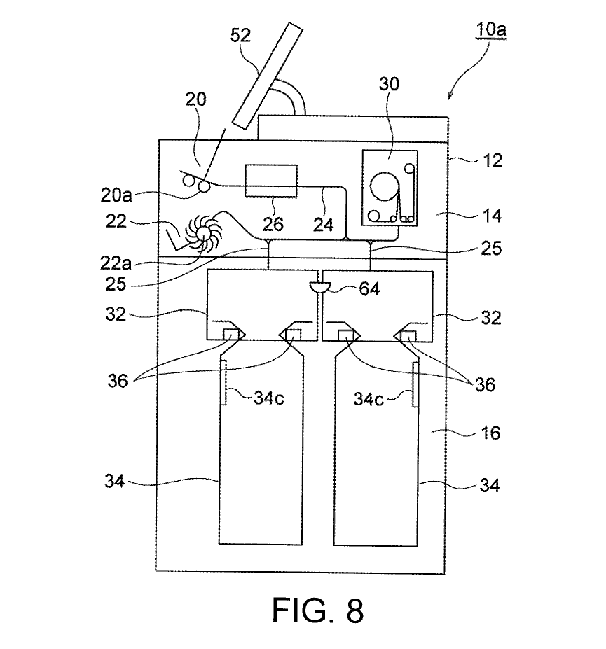

Moreover, instead of using the banknote handling machine 10 having one banknote storing mechanism 32 in the lower unit 16 as shown in FIG. 1, it is allowable to use a banknote handling machine 10a having a plurality of (two in the example shown in FIG. 8) banknote storing mechanism 32 in the lower unit 16 as shown in FIG. 8. In this case, one image capturing unit 64 is arranged for both the banknote storing mechanism 32, and the image capturing unit 64 can capture one image of the inner wall part of the banknote storage bag 34 set in each of the banknote storing mechanism 32. This embodiment is explained below by using FIG. 8 to FIG. 11.

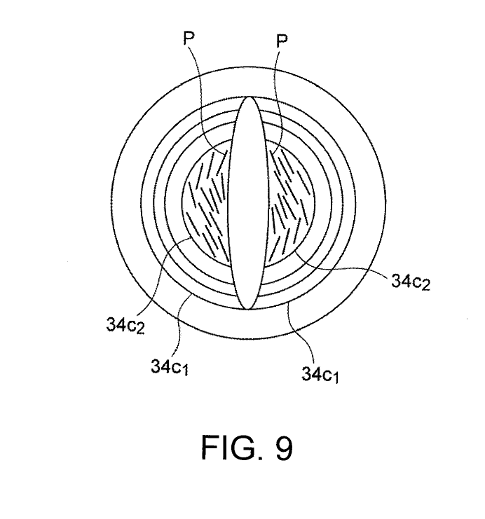

In the banknote handling machine 10a shown in FIG. 8, the image capturing unit 64, such as a camera, is arranged between the two banknote storing mechanism 32. The camera and the like that constitutes the image capturing unit 64 is provided with a fisheye lens or a wide-angle lens. An image captured by the image capturing unit 64 looks like the one shown in FIG. 9. A left half of the image shown in FIG. 9 is an image of the inside of the banknote storage bag 34 set in the left banknote storing mechanism 32 in FIG. 8, and a right half of the image shown in FIG. 9 is an image of the inside of the banknote storage bag 34 set in the right banknote storing mechanism 32 in FIG. 8. Note that, in FIG. 9, the banknote stored in the banknote storage bag 34 is shown with the reference letter P. In this manner, because the camera and the like that constitutes the image capturing unit 64 has the fisheye lens or the wide-angle lens, the image of the inside of the two banknote storage bags 34 can be captured simultaneously with one image capturing unit 64.

A plurality of indicator lines that extends horizontally and parallel to each other are formed, as the mark 34c, on the inner wall part near the opening of the banknote storage bag 34 set in each of the banknote storing mechanism 32. More particularly, a reference symbol 34c1 in FIG. 9 depicts an auxiliary line located at a highest level among the auxiliary lines constituting the mark 34c formed on the inner wall part near the opening of the banknote storage bag 34, and a reference symbol 34c2 depicts an auxiliary line located at a lowest level among the auxiliary lines constituting the mark 34c formed on the inner wall part near the opening of the banknote storage bag 34. When the banknotes are stored in the plurality of (specifically, two) banknote storage bags 34 each set in the banknote storing mechanism 32 in the banknote handling machine 10a, the image of the marks 34c formed on the inner wall parts of the banknote storage bags 34 is captured by the image capturing unit 64. The control unit 50 determines the storing state of the banknotes in each of the banknote storage bags 34 based on the image of the inside of the banknote storage bags 34 captured by the image capturing unit 64. For example, in the image of the inside of the two banknote storage bags 34 captured by the image capturing unit 64 as shown in FIG. 9, when the number of auxiliary lines that are not discontinuous by the upper edge of the banknotes stored in any of the banknote storage bag 34 is less than a predetermined number set previously, the control unit 50 determines that this banknote storage bag 34 is full or nearly full. As another example, in the image of the inside of the banknote storage bags 34 captured by the image capturing unit 64, when the total of the number of auxiliary lines that are not discontinuous by the upper edge of the banknotes stored in any of the banknote storage bag 34 and the number of auxiliary lines whose length of the discontinuous parts by the upper edge of the banknotes is equal to or less than a predetermined value set previously, among the auxiliary lines as the mark 34c, is less than a predetermined value set previously, it is allowable for the control unit 50 to determine that the banknote storage bag 34 is full or nearly full.

As the mark 34c, it is allowable to form a plurality of indicator lines that extends horizontally and vertically and parallel to each other on the inner wall part near the opening of each of the banknote storage bags 34. That is, the auxiliary lines can form a grid pattern. In this case, the control unit 50 determines the storing state of the banknotes in the banknote storage bag 34 from the image of the inside of the banknote storage bags 34 captured by the image capturing unit 64 based on a state of incompleteness of some of the square portions among the square portions formed by the auxiliary lines because of the banknotes stored in the banknote storage bag 34. As another example, it is allowable for the control unit 50 to determine the storing state of the banknotes in the banknote storage bags 34 from the image of the inside of the banknote storage bags 34 captured by the image capturing unit 64 based on a distance between the upper edge of the banknotes stored in any of the banknote storage bag 34 and an upper edge of the banknote storage bag 34 or a predetermined reference line. More particularly, assume that a plurality of indicator lines that extends horizontally and parallel to each other are formed on the inner wall part near the opening of each of the banknote storage bags 34 as the mark 34c. In this structure, it is allowable for the control unit 50 to determine that the banknote storage bag 34 is full or nearly full based on the image of the inside of the banknote storage bags 34 captured by the image capturing unit 64 when a distance between the upper edge of the banknotes stored in any of the banknote storage bag 34 and the upper edge of the banknote storage bag 34 or the predetermined reference line (for example, the topmost auxiliary line among the auxiliary lines as the mark 34c) is less than a predetermined distance set previously. As another example, it is allowable for the control unit 50 to determine the storing state of the banknotes in the banknote storage bags 34 from the image of the inside of the banknote storage bags 34 captured by the image capturing unit 64 based on a size of an area between the upper edge of the banknotes stored in any of the banknote storage bag 34 and an upper edge of the banknote storage bag 34 or a predetermined reference line. More particularly, assume that a plurality of indicator lines that extends horizontally and parallel to each other are formed on the inner wall part near the opening of each of the banknote storage bags 34 as the mark 34c. In this structure, it is allowable for the control unit 50 to determine that the banknote storage bag 34 is full or nearly full based on the image of the inside of the banknote storage bags 34 captured by the image capturing unit 64 when the size of the area between the upper edge of the banknotes stored in any of the banknote storage bag 34 and the upper edge of the banknote storage bag 34 or the predetermined reference line (for example, the topmost auxiliary line among the auxiliary lines as the mark 34c) is less than a predetermined size set previously.

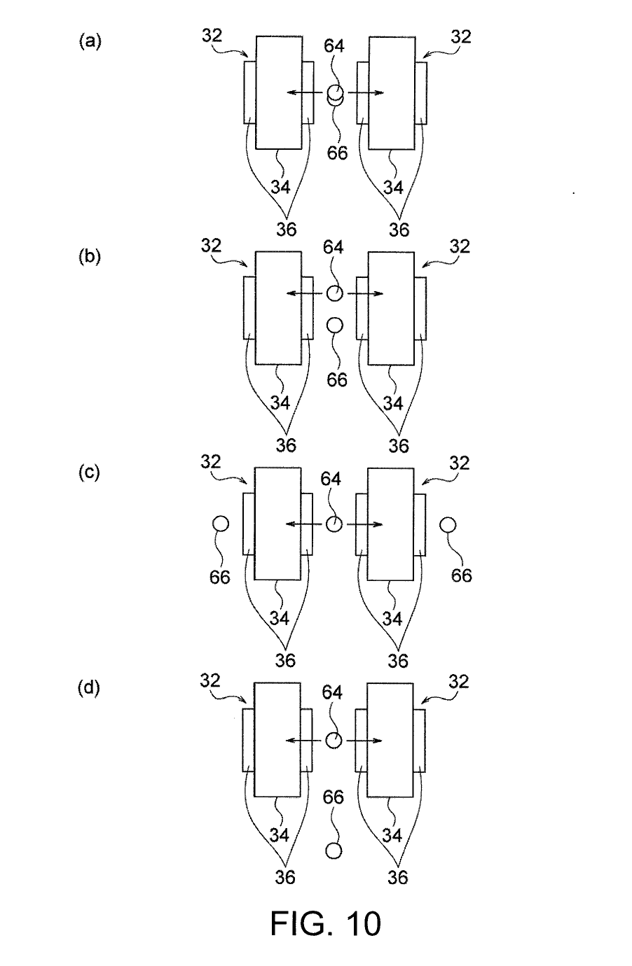

FIGS. 10(a) to 10(d) depict examples of various layouts of the image capturing unit 64 and the light source 66 in the banknote handling machine 10a having the plurality of the banknote storing mechanism 32 shown in FIG. 8. In FIGS. 10(a) to 10(d), imaging directions of the image capturing unit 64 are shown with arrows. As shown in FIG. 10(a), the image capturing unit 64 and the light source 66 can be arranged at the same position between the two banknote storing mechanism 32. In this structure, the light emitted by the light source 66 falls on the two banknote storage bags 34 each set in the banknote storing mechanism 32, and the image capturing unit 64 captures the image of the inside of each of the banknote storage bags 34 that is irradiated with the light of the light source 66. Moreover, as shown in FIG. 10(b), the image capturing unit 64 and the light source 66 can be arranged between the two banknote storing mechanism 32 with a space therebetween. Even in this structure, the light emitted by the light source 66 falls on the two banknote storage bags 34 each set in the banknote storing mechanism 32, and the image capturing unit 64 captures the image of the inside of each of the banknote storage bags 34 that is irradiated with the light of the light source 66. Moreover, as shown in FIG. 10(c), the image capturing unit 64 can be arranged between the two banknote storing mechanism 32, whereas one light source 66 can be arranged on the other side of each of the banknote storing mechanism 32 as seen from the image capturing unit 64 so that an outer part of the banknote storage bag 34 set in each of the banknote storing mechanism 32 can be irradiated with the light. In this structure, when the light emitted by each of the light sources 66 falls on the outer part of the banknote storage bag 34 set in each of the banknote storing mechanism 32, the light passes through as a transmissive light and the inside of the banknote storage bags 34 is irradiated with the transmissive light. Accordingly, the image capturing unit 64 can capture the image of the inside of the banknote storage bags 34 that are irradiated by the transmissive light. Moreover, as shown in FIG. 10(d), the image capturing unit 64 and the light source 66 can be arranged between the two banknote storing mechanism 32 with a space therebetween and an outer part of the banknote storage bag 34 set in each of the banknote storing mechanism 32 can be irradiated with the light from the light source 66. Even in this structure, when the light emitted by the light source 66 falls on the outer part of the banknote storage bag 34 set in each of the banknote storing mechanism 32, the light passes through as a transmissive light and the inside of the banknote storage bags 34 is irradiated with the transmissive light. Accordingly, the image capturing unit 64 can capture the image of the inside of the banknote storage bags 34 that is irradiated by the transmissive light.

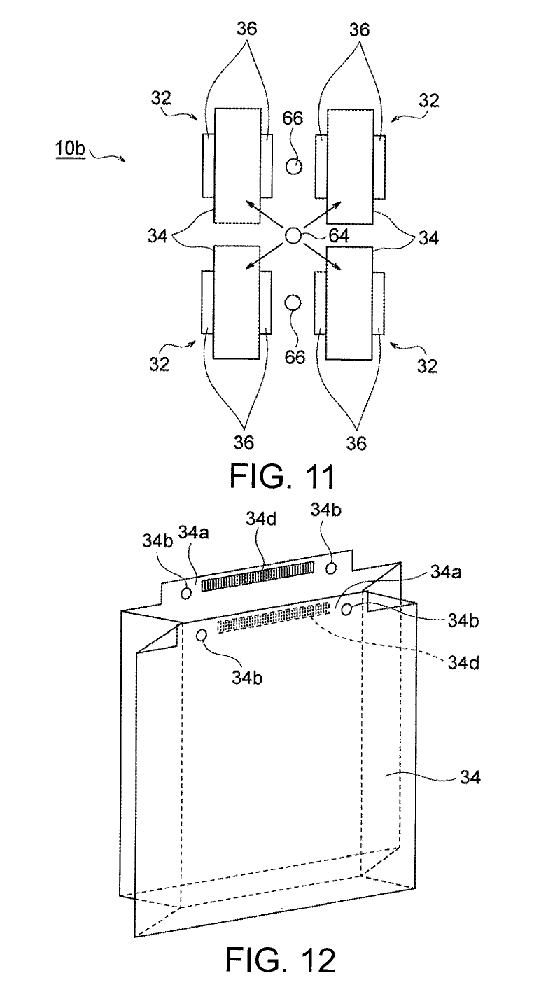

In yet another banknote handling machine according to the present embodiment, four banknote storing mechanism 32 can be arranged in the lower unit 16 as shown in FIG. 11. FIG. 11 depicts a top view of the banknote storing mechanism 32 of a yet another banknote handling machine 10b according to the present embodiment. In the banknote handling machine 10b shown in FIG. 11, the image capturing unit 64 is arranged between the plurality of the banknote storing mechanism 32 like the banknote handling machine 10a shown in FIG. 8 and the like. An image of the inside of the plurality of (specifically, four) banknote storage bags 34 can be captured simultaneously with the image capturing unit 64. More particularly, in the banknote handling machine 10b shown in FIG. 11, the camera and the like that constitutes the image capturing unit 64 is also provided with a fisheye lens or a wide-angle lens. Accordingly, the image of the inside of the four banknote storage bags 34 can be captured simultaneously with the image capturing unit 64. A plurality of indicator lines that extends horizontally and parallel to each other are formed as the mark 34c on the inner wall part near the opening of the banknote storage bag 34 set in each of the banknote storing mechanism 32. When the banknotes are stored in the plurality of (specifically, four) banknote storage bags 34 each set in the banknote storing mechanism 32 in the banknote handling machine 10b, the image of the marks 34c formed on the inner wall parts of the banknote storage bags 34 is captured by the image capturing unit 64. The control unit 50 determines the storing state of the banknotes in each of the banknote storage bags 34 based on the image of the inside of the banknote storage bags 34 captured by the image capturing unit 64.

In the banknote handling machines 10a and 10b shown in FIGS. 8 to 11, because one image capturing unit 64 is arranged for the plurality of the banknote storing mechanism 32, the number of image capturing units 64 can be reduced in comparison to a case in which one image capturing unit 64 is arranged for each of the banknote storing mechanism 32. Thus, the production cost of the banknote handling machines 10a and 10b can be reduced.

In the banknote handling machine 10a in which the plurality of (for example, two) the banknote storing mechanism 32 are arranged in the lower unit 16 as shown in FIG. 8, it is allowable to use, as shown in FIG. 12, the banknote storage bag 34, which should be held by the holding members 36 in each of the banknote storing mechanism 32, on each of the protruding parts 34a of which a barcode 34d (unique information displaying unit) is arranged. When the image of the inside of the banknote storage bags 34 is captured by the image capturing unit 64, an image of the barcode 34d on the protruding part 34a on each of the banknote storage bags 34 is also captured, and the unique information of each of the banknote storage bags 34 can be acquired by reading the information of the corresponding barcode 34d. FIG. 12 is a perspective view of another example of a configuration of the banknote storage bag 34 to be held by the holding members 36 of the banknote storing mechanism 32 of the banknote handling machine 10a shown in FIG. 8.

In the banknote storage bag 34 shown in FIG. 12, the barcode 34d is arranged on an inner part of each of the protruding parts 34a. The barcodes 34d contain the unique information (for example, the information about a type and an identification number of the banknote storage bag 34) about the banknote storage bag 34. When the banknote storage bag 34 is to be held by the holding members 36 shown in FIG. 2, the pins 36a of the holding members 36 are inserted into the corresponding holes 34b formed in the corresponding protruding parts 34a of the banknote storage bag 34. As a result, the protruding parts 34a are held by the holding members 36 and the barcodes 34d face upward. Accordingly, the barcodes 34d also appear in the image captured by the image capturing unit 64. By reading the information contained in the barcodes 34d based on the image captured by the image capturing unit 64, the control unit 50 acquires the unique information about the banknote storage bag 34 set in each of the banknote storing mechanism 32. In this manner, the barcodes 34d are arranged on the inner part of the protruding parts 34a of the banknote storage bag 34, the information contained in the barcodes 34d can be read by capturing the image of the barcodes 34d with the image capturing unit 64, and the unique information about the banknote storage bag 34 set in each of the banknote storing mechanism 32 can be acquired automatically. Accordingly, when setting the banknote storage bag 34 in the banknote storing mechanism 32, if a wrong banknote storage bag 34 is set in the banknote storing mechanism 32, the fact that the wrong banknote storage bag 34 has been set can be detected by the control unit 50. In this case, the efforts put in by the operator can be reduced greatly in comparison to a case in which the barcodes 34d of the banknote storage bag 34, which is set in each of the banknote storing mechanism 32, are, for example, manually read with a barcode reader. Moreover, when setting the banknote storage bags 34 in each of the banknote storing mechanism 32, there is a possibility that a different type of the banknote storage bag 34 is set by mistake instead of the banknote storage bag 34 that actually should have been set in a certain banknote storing mechanism 32. This error can be prevented by first reading the unique information about each of the banknote storage bags 34 with a barcode reader from the barcodes 34d of the banknote storage bags 34, and then setting each of the banknote storage bags 34 in the banknote storing mechanism 32.

Note that, the place where the barcode 34d, which functions as the unique information displaying unit, that contains the unique information about the banknote storage bag 34 can be arranged is not limited to the inner part of the banknote storage bag 34, but can be an outer part of the banknote storage bag 34. Moreover, when the auxiliary lines are arranged on the inner part of the banknote storage bag 34, the barcode 34d can be arranged between these auxiliary lines. Moreover, when a structure in which the barcode 34d is arranged on the inner part of the protruding parts 34a of the banknote storage bag 34 and the image of the barcode 34d is captured by the image capturing unit is adopted, instead of using the image capturing unit 64 that simultaneously captures the image of the inside of the banknote storage bags 34 each set in the banknote storing mechanism 32 as shown in FIG. 8 and the like, it is allowable to arrange one image capturing unit for each of the banknote storing mechanism 32 and capture the image of the barcode 34d of the banknote storage bag 34 set in the corresponding banknote storing mechanism 32 with the corresponding image capturing unit.

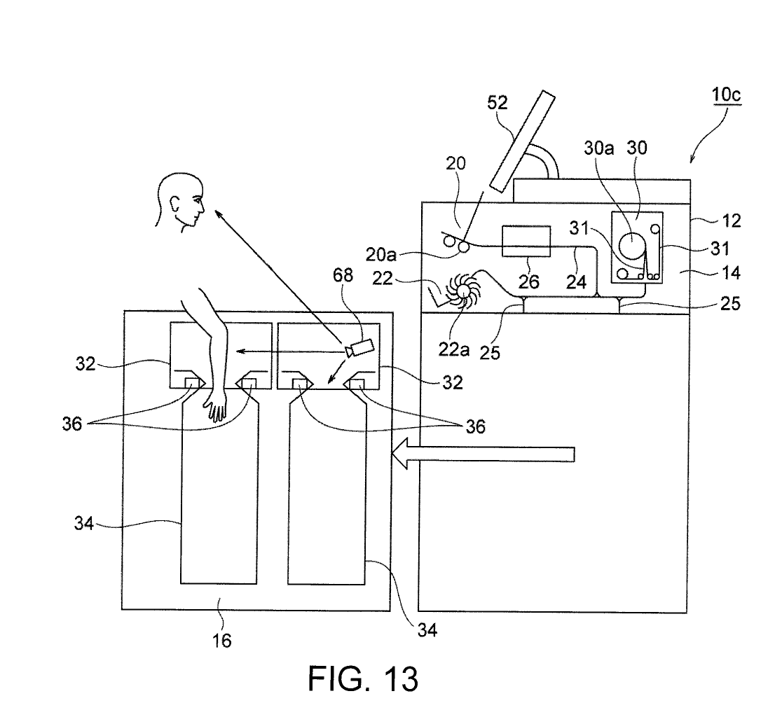

FIG. 13 is a schematic configurational diagram of yet another example of a configuration of the banknote handling machine according to the present embodiment. In a banknote handling machine 10c shown in FIG. 13, as shown with a hollow arrow in FIG. 13, the lower unit 16 is accommodated therein such that it can be pulled out forward (specifically, the left direction in FIG. 13) from the front surface of the housing 12. A plurality of the banknote storing mechanism 32 and an image capturing unit 68 are arranged in the lower unit 16. In the banknote handling machine 10c, the image capturing unit 68 captures an image of the inside of the banknote storage bag 34 set in each of the banknote storing mechanism 32, and the image capturing unit 68 also captures an image of the hand of the operator when the operator attempts to insert his hand in the banknote storage bag 34 set in any of the banknote storing mechanism 32 in a state in which the lower unit 16 has been pulled out forward from the front surface of the housing 12. In this structure, the control unit 50 can detect whether an operation of removing the banknote from the banknote storage bag 34 is performed based on the image captured by the image capturing unit 68. Accordingly, when a need arises to pull the lower unit 16 out from the banknote handling machine 10c, for example, due to occurrence of an error, even if the opening of the banknote storage bag 34 in each of the banknote storing mechanism 32 is kept open, when the banknote is about to be removed from any of the banknote storage bag 34, the fact that the operation of removing the banknote from the banknote storage bag 34 is being performed can be detected based on the image captured by the image capturing unit 68. Accordingly, a storing efficiency of the banknotes can be increased as it is not necessary to heat-seal the opening of the banknote storage bag 34 in each of the banknote storing mechanism 32 each time the lower unit 16 is pulled out. Moreover, when a need arises to pull the lower unit 16 out from the banknote handling machine 10c, for example, due to occurrence of an error, instead of heat-sealing the opening of the banknote storage bag 34, the opening of the banknote storage bag 34 can be sandwiched between the pair of the holding members 36 thereby closing the opening.

As shown with arrows in FIG. 13, it is allowable for the image capturing unit 68 to capture an image of the face of the operator who is attempting to remove the banknote from the banknote storage bag 34 set in any of the banknote storing mechanism 32. In this structure, when the fact that an operation of removing the banknote from the banknote storage bag 34 is being performed is detected based on the image captured by the image capturing unit 68, because the image of the face of the operator who is attempting to remove the banknote from the banknote storage bag 34 is also captured by the image capturing unit 68, the antitheft property when the lower unit 16 is pulled out forward from the front surface of the housing 12 can be improved further.

When a structure is adopted in which not only the image of the inside of the banknote storage bag 34 that is set in each of the banknote storing mechanism 32 but also the image of the face or the hand of the operator who is attempting to remove the banknote from any of the banknote storage bag 34 is captured by the image capturing unit 68 arranged in the lower unit 16, the camera and the like that constitutes the image capturing unit 68 is provided with a fisheye lens or a wide-angle lens. Alternatively, it is allowable to always change an imaging direction of the image capturing unit 68 within a predetermined angle range.

Moreover, in the banknote handling machine 10c shown in FIG. 13, it is allowable for the control unit 50 to detect, based on the image of the inside of the banknote storage bags 34 captured by the image capturing unit 68, whether the status inside any of the banknote storage bag 34 has changed before and after the lower unit 16 was pulled out forward from the front surface of the housing 12. When it is detected by the control unit 50, based on the image of the inside of the banknote storage bags 34 captured by the image capturing unit 68, that the status inside any of the banknote storage bag 34 has changed before and after the lower unit 16 was pulled out forward from the front surface of the housing 12, the control unit 50 can determine that the banknote is removed from the banknote storage bag 34 when the lower unit 16 was pulled out forward from the front surface of the housing 12.

Note that the paper sheet handling machine according to the present invention and the paper sheet storing mechanism included in the paper sheet handling machine are not limited to the above-mentioned banknote handling machines 10, 10a, 10b, and 10c that perform various processes such as the money deposition process of the banknote, and to the banknote storing mechanism 32 included in the banknote handling machines 10, 10a, 10b, and 10c. A device that can handle the paper sheet such as a check and a gift certificate, other than the banknote, can be used as the paper sheet handling machine and the paper sheet storing mechanism according to the present invention.

1. A paper sheet storing mechanism that stores a paper sheet in a storage bag having an opening on one side thereof, comprising:
a holding unit for holding a part near the opening of the storage bag;
an image capturing unit that captures an image of an inside of the storage bag held by the holding unit; and
a control unit that determines a storing state of the paper sheet in the storage bag based on the image of the inside of the storage bag captured by the image capturing unit.

2. The paper sheet storing mechanism as claimed in claim 1, wherein, upon determining that the storing state of the paper sheet in the storage bag held by the holding unit is a predetermined storing state, the control unit outputs information representing that the storing state of the paper sheet in the storage bag is the predetermined storing state.

3. The paper sheet storing mechanism as claimed in claim 2, further comprising an alarm unit that raises an alarm, when the control unit determines that the storing state of the paper sheet in the storage bag held by the holding unit is the predetermined storing state, that the storing state of the paper sheet in the storage bag is the predetermined storing state, based on the information output from the control unit.

4. The paper sheet storing mechanism as claimed in claim 1, wherein a mark for determining the storing state of the paper sheet in the storage bag is arranged on an inner part of the storage bag to be held by the holding unit.

5. The paper sheet storing mechanism as claimed in claim 4, wherein
the mark includes a plurality of indicator lines that extends parallel to each other, and
the control unit determines the storing state of the paper sheet in the storage bag from the image of the inside of the storage bag captured by the image capturing unit based on a state of discontinuity of one or some of the auxiliary lines among the auxiliary lines because of the paper sheet stored in the storage bag.

6. The paper sheet storing mechanism as claimed in claim 1, wherein the control unit determines the storing state of the paper sheet in the storage bag from the image of the inside of the storage bag captured by the image capturing unit based on a distance between an upper edge of the paper sheet stored in the storage bag and an upper edge of the storage bag or a predetermined reference line.

7. The paper sheet storing mechanism as claimed in claim 1, wherein the control unit determines the storing state of the paper sheet in the storage bag from the image of the inside of the storage bag captured by the image capturing unit based on a size of an area between an upper edge of the paper sheet stored in the storage bag and an upper edge of the storage bag or a predetermined reference line.

8. The paper sheet storing mechanism as claimed in claim 1, wherein
information about a counting result representing number of paper sheets sent in the storage bag held by the holding unit is sent to the control unit, and
the control unit determines the storing state of the paper sheet in the storage bag based on both the image of the inside of the storage bag captured by the image capturing unit and the number of paper sheets sent in the storage bag.

9. The paper sheet storing mechanism as claimed in claim 1, further comprising a light source that emits a light on the storage bag held by the holding unit.

10. (canceled)

11. (canceled)

12. The paper sheet storing mechanism as claimed in claim 1, wherein the image capturing unit is capable of capturing the image of the inside of a plurality of the storage bags held by the holding units.

13. The paper sheet storing mechanism as claimed in claim 12, wherein the image capturing unit includes a fisheye lens or a wide-angle lens.

14. The paper sheet storing mechanism as claimed in claim 1, wherein the control unit acquires unique information about the storage bag based on the image of the storage bag captured by the image capturing unit.

15. The paper sheet storing mechanism as claimed in claim 14, wherein a unique information displaying unit indicating the unique information of the storage bag is arranged on an inner part or an outer part of the storage bag to be held by the holding unit.

16. The paper sheet storing mechanism as claimed in claim 1, wherein the control unit is capable of detecting an operation of removing the paper sheet from the storage bag based on the image of the storage bag captured by the image capturing unit.

17. The paper sheet storing mechanism as claimed in claim 1, further comprising a pressing unit that enters into the storage bag held by the holding unit and presses the paper sheet stored inside the storage bag, wherein
based on the image of the inside of the storage bag captured by the image capturing unit, upon determining that the storing state of the paper sheet in the storage bag is the predetermined state, the control unit controls the pressing unit to press the paper sheet stored inside the storage bag.

18. A paper sheet handling machine that handles a paper sheet, comprising:
a paper sheet storing mechanism that stores the paper sheet in a storage bag having an opening on one side thereof and includes
a holding unit for holding a part near the opening of the storage bag, and
an image capturing unit that captures an image of an inside of the storage bag held by the holding unit;
a body unit that sends the paper sheet to the paper sheet storing mechanism; and
a control unit that determines a storing state of the paper sheet in the storage bag based on the image of the inside of the storage bag captured by the image capturing unit.

19. The paper sheet handling machine as claimed in claim 18, wherein, upon determining that the storing state of the paper sheet in the storage bag held by the holding unit of the paper sheet storing mechanism is a predetermined storing state, the control unit outputs information representing that the storing state of the paper sheet in the storage bag is the predetermined storing state.

20. The paper sheet handling machine as claimed in claim 19, further comprising an alarm unit that raises an alarm, when the control unit determines that the storing state of the paper sheet in the storage bag held by the holding unit of the paper sheet storing mechanism is the predetermined storing state, based on the information output from the control unit, that the storing state of the paper sheet in the storage bag is the predetermined storing state.

21. The paper sheet handling machine as claimed in claim 18, further comprising:
a housing; and
a drawing unit that is capable of being pulled out of the housing, wherein
the holding unit and the image capturing unit are arranged in the drawing unit, and
the control unit, based on the image of the storage bag captured by the image capturing unit, is capable of detecting an operation of removing the paper sheet from the storage bag after the drawing unit has been pulled out of the housing.

22. A paper sheet storing method for storing a paper sheet in a storage bag having an opening on one side thereof, comprising:
sending the paper sheet into the storage bag to store the paper sheet in the storage bag;
capturing an image of an inside of the storage bag with an image capturing unit; and
determining a storing state of the paper sheet in the storage bag based on the image of the inside of the storage bag captured by the image capturing unit.
